(19) United States
(12) Patent Application Publication
(10) Pub. No.: US 2026/0107071 A1
(43) Pub. Date: Apr. 16, 2026

(54) A DEVICE AND A METHOD FOR THE PLENOPTIC RECONSTRUCTION OF INDIRECT IMAGES OF AN OBJECT

(71) Applicants: INRiM-Istituto Nazionale di Ricerca Metrologica, Torino (IT); Università degli Studi di Bari Aldo Moro, Bari (IT)

(72) Inventors: Milena D'ANGELO, Bari (IT); Augusto GARUCCIO, Bari (IT); Francesco Vincenzo PEPE, Bari (IT); Alberto PANIATE, Torino (IT); Alessio AVELLA, Torino (IT); Alice MEDA, Torino (IT); Ivano RUO BERCHERA, Torino (IT); Marco GENOVESE, Torino (IT)

(21) Appl. No.: 19/114,671

(22) PCT Filed: Sep. 26, 2023
(86) PCT No.: PCT/IB2023/059525

§ 371 Date: Mar. 24, 2025

(30) Foreign Application Priority Data
Sep. 26, 2022 (IT) 102022000019749

(51) Int. Cl. H04N 23/957

(52) U.S. Cl. CPC H04N 23/957

(57) ABSTRACT

Disclosed herein is a device for the plenoptic reconstruction of indirect images of an object. Unlike prior art techniques, it is possible to overcome the problem of focusing the indirect image in the case of the object being positioned outside a focusing plane without requiring new acquisitions of the image itself, thanks to the features of the disclosed plenoptic image acquisition device. Although the indirect image is visible only after an evaluation of the correlations, if such image is out of focus it is possible to perform a refocusing by using the data available in the plenoptic acquisition. Therefore, it becomes possible to reconstruct the indirect image of objects irrespective of their location, as well as of moving objects.

### FIELD OF THE INVENTION

The present invention refers to devices and methods for the indirect reconstruction of images, commonly known as ghost imaging.

### PRIOR ART

Ghost Imaging (GI) is a non-invasive technique by means of which it is possible to reconstruct the image of an object without the need of a detector provided with spatial resolution that is adapted to acquire the image of the object directly. The image is obtained by using two spatially correlated electromagnetic emissions: the former, i.e., the reference emission (the emission of the spatial arm), never interacts with the object and it is measured by means of a detector with spatial resolution; the latter, i.e., the emission which illuminates the object, is measured by a single pixel detector (a so-called bucket detector) which has no spatial resolution. The image is reconstructed by correlating in time the intensity of the signals collected by each pixel of the sensor on the reference arm (or spatial arm) with the signals recorded by the single pixel detector in the object arm.

The ghost imaging only acquires images of a correlated electromagnetic emission which, as a principle, may be located anywhere, provided that it is correlated with the electromagnetic emission impinging upon the object, and which is acquired by a single pixel sensor.

In other words, ghost imaging is based on the assumption that the intensity distribution of the electromagnetic emission recorded by the detector with spatial resolution is correlated with the intensity distribution of the electromagnetic emission which interacts with the object. Because the intensity distributions of both emissions vary during the technical requirements for propagation, one of ghost imaging is an accurate knowledge of the position of the object plane.

In practice, reconstructing an indirect image (ghost image) in conditions other than laboratory conditions is not easy, because the need of having correlated electromagnetic emissions (particularly light rays) limits the positioning of the object on a well-defined plane, which in real operating conditions is not always known with sufficient accuracy. In this the reconstruction of the image with an regard, acceptable signal-to-noise ratio requires the acquisition of a high number of frames the and subsequent calculation of the correlations; therefore, an approach by trial and error in order to find a focused image of an object having an unknown position requires a very long time or it is even impossible, if the object is moving, or it is even subject to damages due to radiation.

This situation may reduce the field of applicability of ghost imaging because, unlike the conventional techniques of imaging, the focusing may not be obtained with a single intensity measurement, as the indirect image is visible only after the evaluation of the correlations. In other words, the ghost imaging does not enable an acquisition or a reconstruction of images in real time.

### OBJECT OF THE INVENTION

The present invention aims at solving the technical problems described in the foregoing. Specifically, the object of the invention is using the technique of ghost imaging for image reconstruction, while loosening the constraints about the knowledge of the position of the plane of the object and/or of the state (standstill or motion) of the object.

### SUMMARY OF THE INVENTION

The object of the invention is achieved by means of a device and of a method having the features set forth in the claims that follow, which form an integral part of the technical disclosure provided herein in relation to the invention.

### BRIEF DESCRIPTION OF THE FIGURES

The invention will now be described with reference to the annexed Figures, which are provided by way of non-limiting example only, and wherein:

FIGS. 1, 2, 2A, 3, 4 each show an embodiment of a device according to the invention,

FIGS. 5A to 5D show applications of the devices according to the invention with different types of objects,

FIGS. 6 to 10 show further embodiments of the invention, which feature different configurations of the spatial arm.

### DETAILED DESCRIPTION

The reference numbers 10, 20, 30, 40, 50, 60, 70, 80, 90, 100 in the Figures listed in the foregoing denote corresponding embodiments of a device for the plenoptic reconstruction of indirect images according to the invention.

In various embodiments, the device 10, 20, 30, 40, 50, 60, 70, 80, 90, 100 comprises:
a first electromagnetic emission detector BD, configured to be impinged upon by a first electromagnetic emission E1, specifically a light emission, coming from a source S and having a first propagation path P1 wherein, in use, an object OBJ of which the indirect image is to be reconstructed is arranged along the first propagation path P1,
a second electromagnetic emission detector PC, configured to be impinged upon by a second electromagnetic emission E2, specifically a light emission, coming from the source S and having a second propagation path P2.

The first electromagnetic emission detector BD is a so-called “bucket detector”, and comprises a first (single) sensor element configured to emit a signal proportional to the intensity of the first electromagnetic emission E1 impinging upon the first sensor element. The object OBJ is arranged along the propagation path P1 between the detector BD and the source S.

According to the invention, the second electromagnetic emission detector PC comprises a plenoptic image acquisition device (i.e., a so-called lightfield image acquisition device; throughout the description, reference PC may therefore be used in order to denote a plenoptic image acquisition device), which comprises a second sensor element configured to detect both a spatial distribution of the intensity of the second electromagnetic emission E2, and information a direction of origin of the second about electromagnetic emission E2 at a plurality of spatial locations on the second sensor element.

In various embodiments the device 10, 20, 30, 40, 50, 60, 70, 80, 90, 100 moreover comprises a processing unit, configured to reconstruct an indirect image, or ghost image, of the object OBJ by means of a correlation measure of the signals coming from the electromagnetic emission detectors BD and PC. Specifically, the correlation measure is obtained based on a reconstruction of the electromagnetic emission E2 on a focusing plane π by using the information coming from the second electromagnetic emission detector PC, especially the signals coming from the second sensor element. The plane π is arranged upstream the detector PC and at a distance z_{b} from source S.

The processing unit may conveniently be provided as a device external to device 10, 20, 30, 40, 50, 60, 70, 80, 90, 100, or else it is possible to envisage an integrated structure wherein the control unit is a part of the device 10, 20, 30, 40, 50, 60, 70, 80, 90, 100.

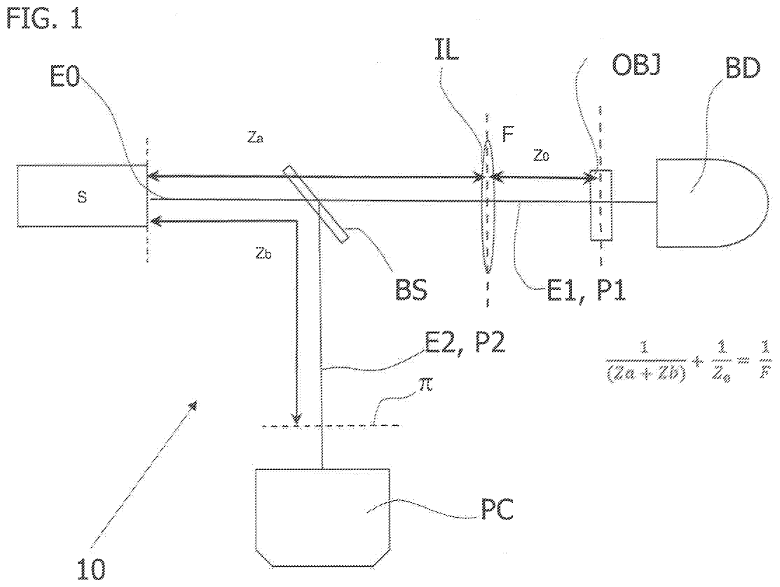

The various embodiments in FIGS. 1 to 10 aim at showing different functional and/or structural configurations of the basic device according to the invention.

FIGS. 1 to 4 show embodiments of the device according to the invention which differ from each other in the type of source S originating the electromagnetic emission an/or in the configuration of the device.

With reference to FIG. 1, in the device 10 the first electromagnetic emission E1 and the second electromagnetic emission E2 are secondary electromagnetic emissions. Specifically, the correlated emissions E1 and E2 are separated from one and the same primary electromagnetic emission E0, which originates from a single source S which corresponds to a quantum optical source. Examples of such a source include an SPDC (Spontaneous Parametric Down Conversion) source, an FWM (Four Wave Mixing) source, an atomic cascade source.

To this end, the device 10 comprises a beam splitter BS, configured to be impinged upon by the emission E0 and to separate the emission E0 into the emissions E1 and E2. As regards the so-called “object arm”, i.e., the optical arm wherein the electromagnetic emission impinges upon the object OBJ and the latter is “seen” by the detector BD, a lens IL having a focal length F has a reference plane located at a distance za from the light source S and at a distance z₀ from the object OBJ, which is arranged between the lens IL and the detector BD. For instance, in the case of a thin lens, the reference plane coincides with the plane of the lens, while in the case of thick lenses the reference plane may comprise one of the main planes of the lens or the abutment of the lens.

As regards the so-called “spatial arm”, the emission E2 has a propagation path P2 which originates with the emission E0 and ends by impinging upon the plenoptic image acquisition device PC. The focusing plane π, whereat the indirect image of the object OBJ is reconstructed (as described in the foregoing), is arranged at a distance z_{b} from the source S and upstream the detector PC.

As shown in the Figure, in order to reconstruct the indirect image of the object OBJ focused on plane π, in the ghost imaging the following relationship must be met: 1/(zₐ+z_{b})+1/z₀=1/F. If such a condition is not verified, the images out of focus may be refocused by using the plenoptic information provided by the plenoptic image acquisition device PC.

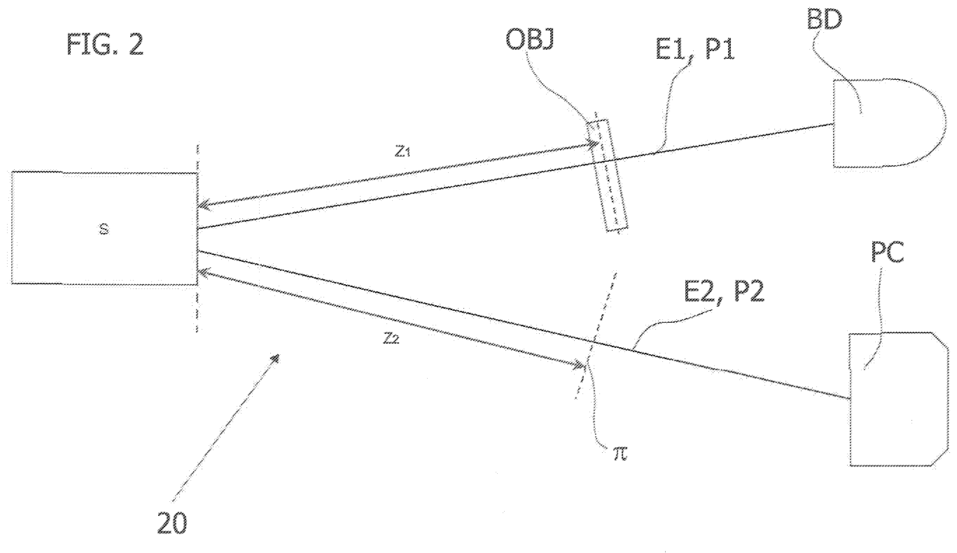

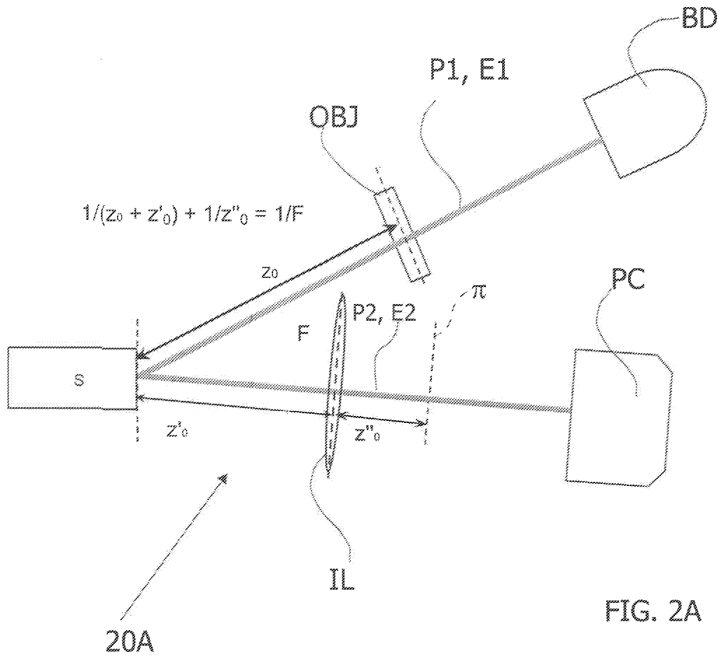

With reference to FIG. 2, the device 20 differs from the device 10 due to the absence of both lens IL and beam splitter BS. The source S is a quantum optical source which produces two correlated emissions. Examples of such a source comprise an SPDC (Spontaneous Parametric Down Conversion) source, an FWM (Four Wave Mixing) source, an atomic cascade source. In the device 20, the first electromagnetic emission E1 and the second electromagnetic emission E2 are primary electromagnetic emissions of the same source S. As regards the so-called “object arm”, i.e., the optical arm wherein the electromagnetic emission E1 impinges upon the object OBJ, such an arm is located between the source S and the detector BD at a distance z₁ from the source S itself.

As regards the spatial arm, the emission E2 has a propagation path P2 which develops from the source S to the plenoptic image acquisition device PC. The focusing plane π whereat the indirect image of the object OBJ is reconstructed is located at a distance z₂ from source S. The indirect image on the plane π is focused if the distances z₁ and z₂ are the same. If this is not the case, the images out of focus may be refocused by using the plenoptic information provided by the plenoptic image acquisition device PC.

In the diagram of FIG. 2, the distances z₁ e z₂ are chosen so that they are located in the far field with respect to source S; such a condition may be achieved by means of lenses or free propagation).

With reference to FIG. 2A, the device 20A differs from the device 20 due to the presence of the lens IL. The source S is once again a quantum optical source, which produces two correlated emissions. In the device 20A, the first electromagnetic emission E1 and the second electromagnetic emission E2 are primary electromagnetic emissions of the same source S. As regards the so-called “object arm”, i.e. the optical arm wherein the electromagnetic emission E1 impinges upon the object OBJ, the latter is located between the source S and the detector BD at a distance z₀ from source S itself.

As regards the spatial arm, a lens having a focal length F has a reference plane arranged at a distance z′₀ from source S. The focusing plane π of the indirect image of the object OBJ is arranged at a distance z″₀ from the reference plane of the lens IL and upstream the detector PC. As shown in the Figure, in order to reconstruct the indirect image of the object OBJ the following relationship must be met:

$$1 / ( {z}_{0} + {z}_{0}^{′} ) + 1 / {z}_{0}^{″} = 1 / F$$

If said condition is not verified, the images out of focus may be refocused by using the plenoptic information provided by the plenoptic image acquisition device PC.

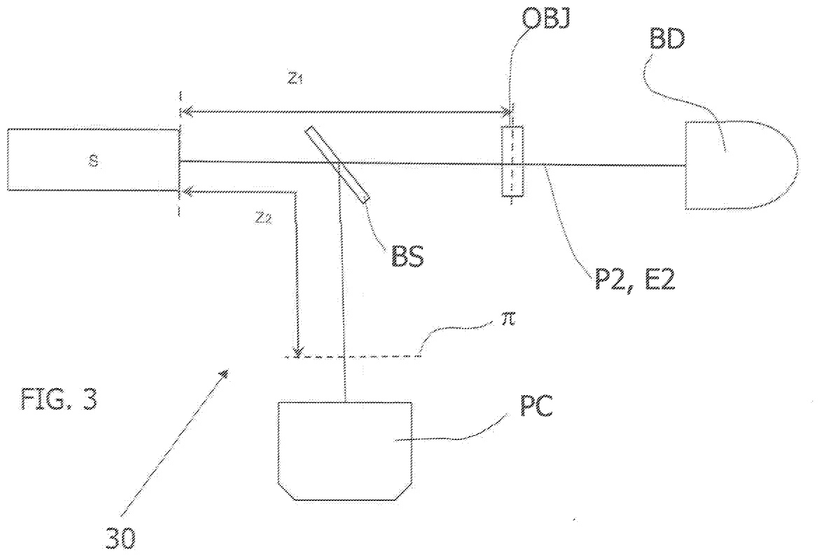

With reference to FIG. 3, the device 30 substantially corresponds to a hybrid configuration of FIGS. 1 and 2. This device keeps the general structure of FIG. 1, with the beam splitter BS, but it has no lens IL. The source S is a chaotic optical source, e.g., a thermal or pseudo-thermal light. The beam splitter BS is arranged in the view of the source, and it is configured to be impinged upon by the emission E0 and to separate the emission E0 into the emissions E1 and E2. As regards the object arm, the object OBJ is arranged at a distance z₁ from the light source S, and it is located between the source S and the detector BD.

As regards the spatial arm, the emission E2 has a propagation path P2 originating with the emission E0 and ending by impinging upon the plenoptic image acquisition device PC. The focusing plane π whereat the indirect image of the object OBJ is formed is arranged at a distance z₂ from source S. In order to reconstruct the focused indirect image of the object OBJ on the focusing plane π, the distances z₁ and z₂ must be identical in the ghost imaging. If this is not the case, the images out of focus may be refocused by using the plenoptic information provided by the plenoptic image acquisition device PC.

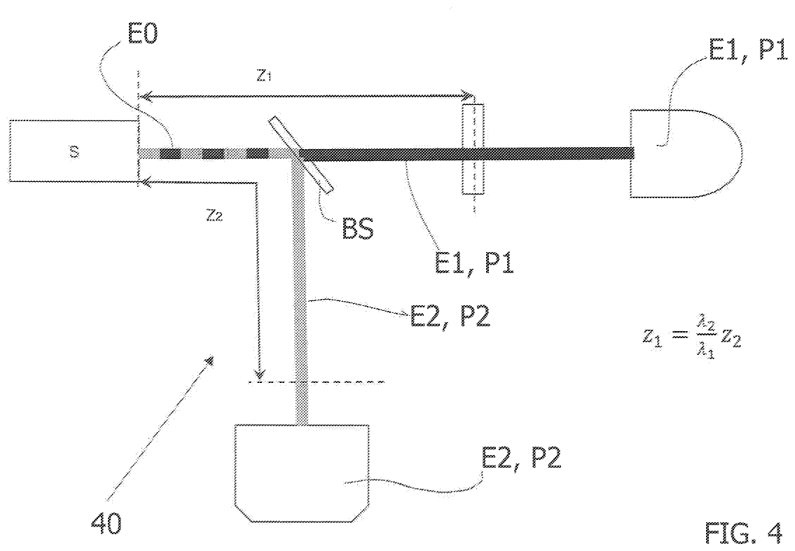

The device 40 in FIG. 4 is similar to device 30, but the source S is a classical or quantum optical source which generates a primary emission E0 having two different wavelengths. To this end, the device 40 comprises a dichroic mirror or a beam splitter BS, which is located in the view of source S and is configured to be impinged upon by the emission E0 and to separate the emission E0 into the emissions E1 and E2, respectively at the two wavelengths. As regards the object arm, the object OBJ is arranged at a distance z₁ from the light source S, and it is located between the source S and the detector BD.

As regards the spatial arm, the emission E2 has a propagation path P2 which originates with the emission E0 and ends by impinging upon the plenoptic image acquisition device PC. The focusing plane π whereat the indirect image of the object OBJ is formed is arranged at a distance z₂ from source S. In order to reconstruct the focused indirect image of the object OBJ on the focusing plane π, the distances z₁ and z₂ must meet, in the ghost imaging, the relationship z₁=(λ₂/λ₁)z₂, wherein λ₁ and λ₂ are the wavelengths of the light in the object arm (secondary emission E1) and in the spatial arm (secondary emission E2). If this is not the case, the images out of focus may be refocused by using the plenoptic information provided by the plenoptic image acquisition device PC.

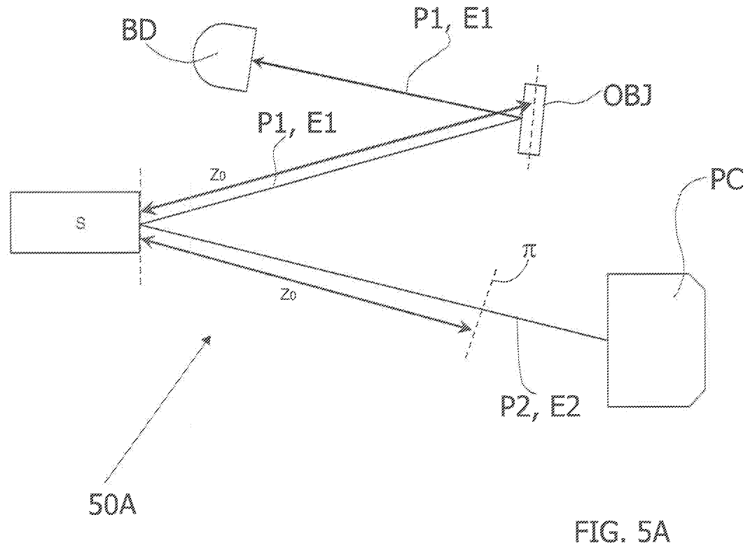

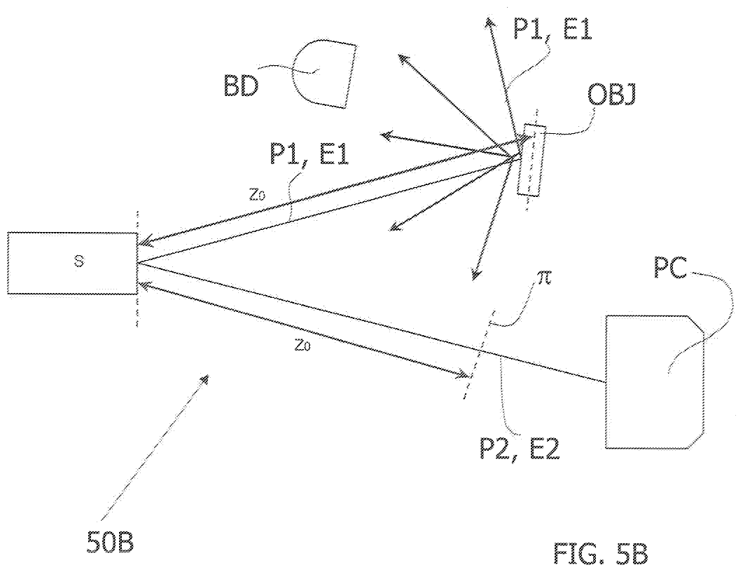

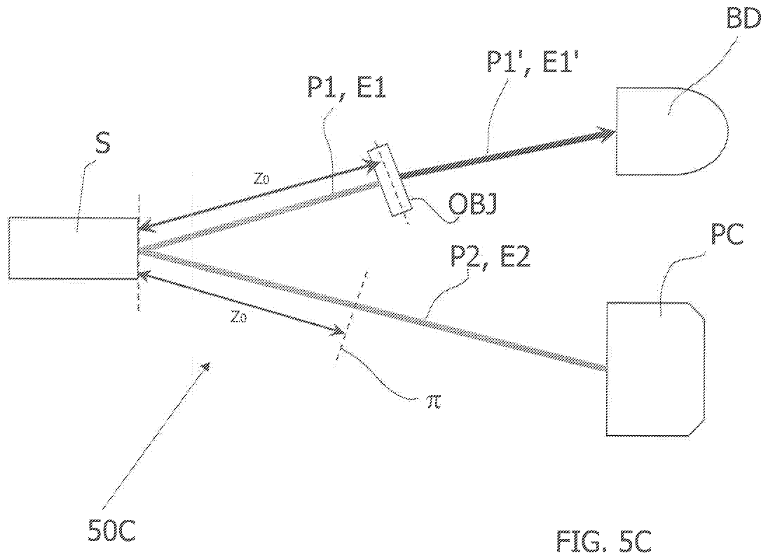

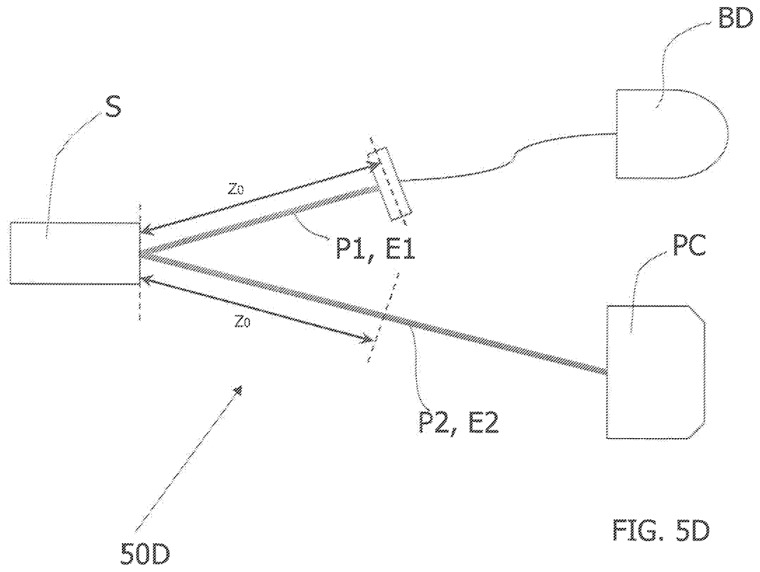

The diagrams in FIGS. 5A-5D show the behaviour of the devices according to the invention (of all the devices 10-100, although for simplicity only one of them is shown in each example) in the presence of reflective objects OBJ (device 50A, FIG. 5A; the detector BD is obviously arranged on the same side of the source S with respect to the object, the latter being reflective), diffusive objects (device 50B, FIG. 5B), emitting objects (device 50C, FIG. 5C; the emission E1, P1 continues as emission E1′, P1′) and objects OBJ which behave as transductors (device 50D, FIG. 5D).

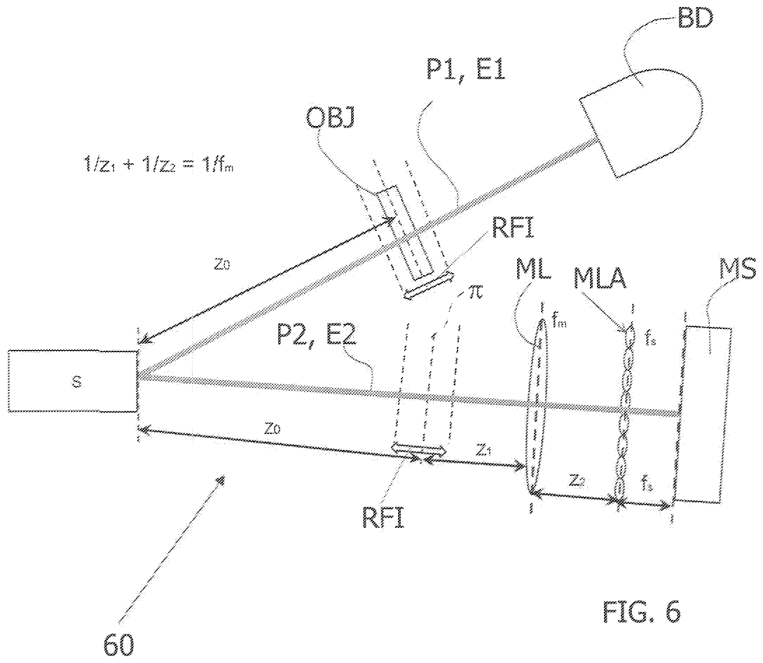

With reference to FIGS. 6 to 10, there will now be described embodiments of the device according to the invention which differ from each other in the configuration of the plenoptic detector PC. Again, the reference diagram is the same as in FIG. 2 (the choice is made by way of example only), but the structure of detector PC is more detailed in comparison with the former diagram.

With reference to FIG. 6, the device 60 includes a plenoptic image acquisition device PC as described in the foregoing, commonly known as “plenoptic camera 1.0”. The plenoptic image acquisition device of the device 60 comprises a micro-lens array MLA, having a focal length fₛ, a main lens ML having a focal length fₘ, and a sensor element MS with a pixel array configuration, wherein the micro-lens array MLA is arranged between the micro-lens array ML and the sensor element MS.

The sensor element MS is positioned at a distance fₛ from the micro-lens array MLA, i.e., at a distance corresponding to the focal length fₛ. The main lens ML is arranged at a distance z₂ from the micro-lens array MLA, while the focusing plane π whereon the indirect image is formed is positioned at a distance z₁ from the main lens ML, so as to meet the relationship 1/z₁+1/z₂=1/fₘ. In other words, the main lens ML is configured to recreate the image of the focusing plane π (where the indirect image is reconstructed according to the procedure described in the foregoing) on the plane whereon the micro-lens array MLA is positioned. Moreover, each micro-lens produces, on the sensor, the far field of the light which impinges upon it. The distance z₀ between the object OBJ and the source S, and between the plane π and the source S, may have any length in the case of a source S of chaotic light, whereas if the source S emits a quantum regulated electromagnetic radiation the distance z₀ must be such as to guarantee that the object and the plane π are in the far field of the source S itself. The images out of focus on the plane π may be refocused by using the plenoptic information provided by the plenoptic image acquisition device PC.

Reference RFI denotes the refocusing interval of the plenoptic camera PC, i.e., the beam of parallel planes whereon it is possible to refocus the indirect image of the object.

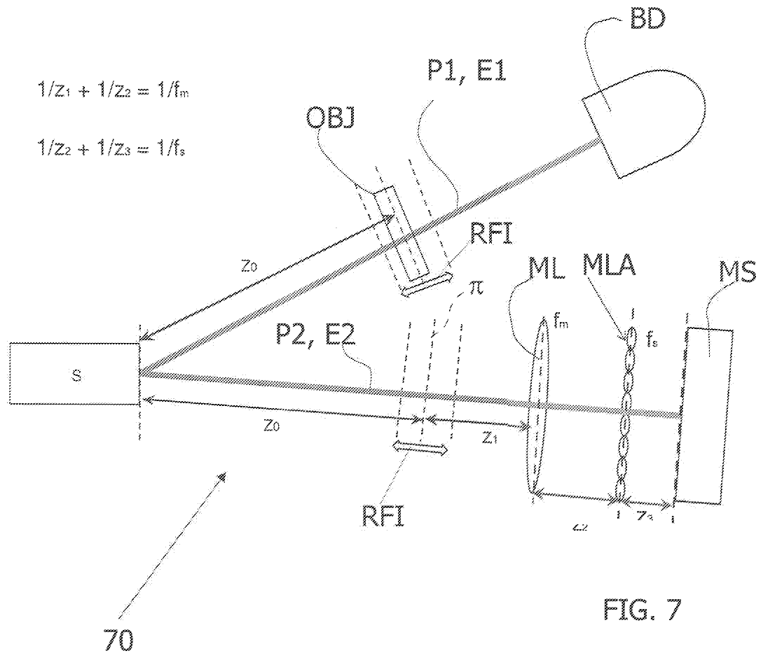

With reference to FIG. 7, the device 70 is configured as a modification of the device 60 so that, again, the main lens ML is configured to create the indirect image of the object OBJ on the micro-lens array MLA.

In this case, the sensor element MS is positioned at a distance 23 from the micro-lens array MLA, the main lens ML is positioned at a distance z₂ from the micro-lens array MLA, whereas the focusing plane π whereat the indirect image is formed is positioned at a distance z₁ from the main lens ML. Each micro-lens of the array MLA forms the image of the main lens ML on a respective (generally small) portion of the sensor.

In order that each micro-lens projects the focused image of the plane of the lens ML onto the sensor MS, the following relationship must be met: 1/z₂+1/z₃=1/fₛ. In order that the lens ML projects the plane π onto the plane of the micro-lenses MLA, the following relationship must be met: 1/z₁+1/z₂=1/fₘ. If this is not the case, the images out of focus may be refocused by using the plenoptic information provided by the plenoptic image acquisition device PC.

The distance z₀ between the object OBJ and the source and between the plane π and the source may be of any length in the case of a source S with chaotic light, whereas it must be such that the object is located in the far field if the source S emits entangled photons. As in the case of device 60, the value RFI represents the operating interval of the plenoptic camera PC, i.e., the beam of parallel planes whereon it is possible to refocus the indirect image of the object.

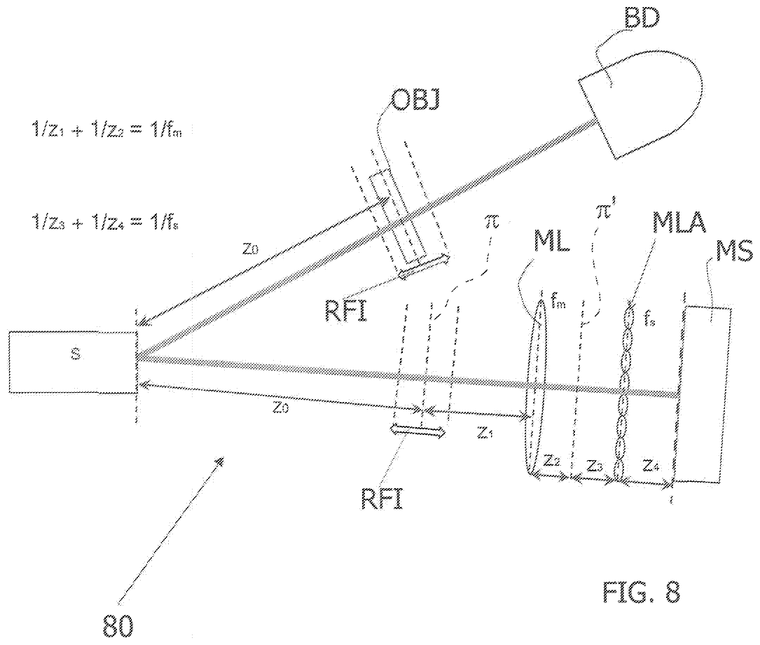

With reference to FIG. 8, the device 80 is configured as a modification of the device 70, wherein the main lens ML is configured to create the indirect image of the object OBJ on an intermediate plane π′ arranged between the micro-lens array MLA and the lens ML itself.

Moreover, each micro-lens forms an image of the plane π′ in a corresponding portion of sensor MS.

The plenoptic image acquisition device PC of the device 80 is commonly known as plenoptic camera 2.0.

The sensor element MS is positioned at a distance 24 from the micro-lens array ML, the main lens ML is positioned at a distance z₂ from the plane π′, whereas the micro-lens array MLA is positioned at a distance z₃ from the plane π′. The focusing plane π on which the focused indirect image is formed is positioned at a distance z₁ from the main lens ML.

In order that the indirect image is focused on the plane π′, the following relationship must be met: 1/z₁+1/z₂=1/fₘ whereas, in order that the image of the plane π′ is formed on the sensor for each microlens, the following relation must be met: 1/z₃+1/z₄=1/fₛ. If the former condition is not verified, the images out of focus may be refocused by using the plenoptic information provided by the plenoptic image acquisition device PC.

The distance z₀ between the object OBJ and the source and between the plane π and the source may be of any length in the case of a source S having a chaotic light, wheareas it must be in the far field if the source S emits entangled photons. As in the case of device 60, the value RFI represents the operating interval of the plenoptic camera PC, i.e., the beam of parallel planes for which it is possible to refocus the indirect image of object OBJ.

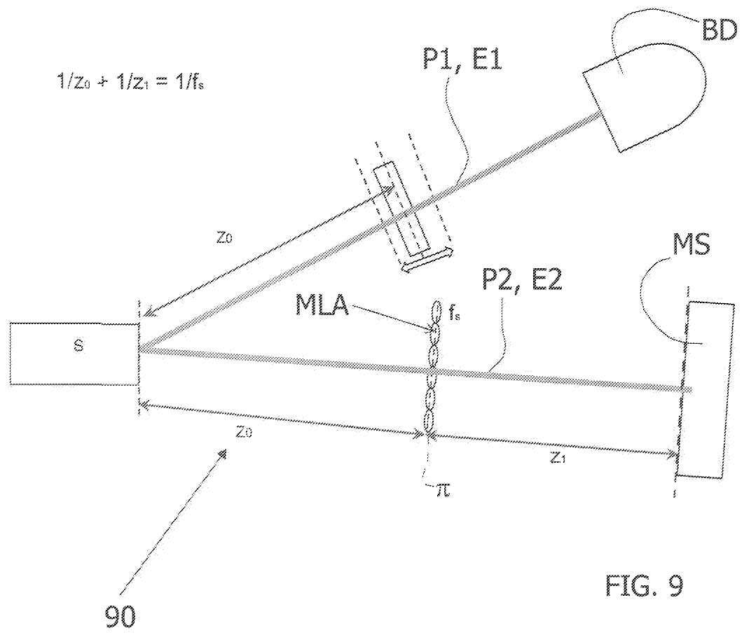

With reference to FIG. 9, the device 90 is configured as a modification of the device 60 without the main lens ML, and wherein the micro-lens array MLA is arranged at a position coinciding with the focusing plane π on which the indirect image of the object OBJ is reconstructed. In this configuration, each of the micro-lenses forms an image of the source on a corresponding portion of the sensor element MS. The plenoptic image acquisition device PC of device 90 is once again of the type commonly known as plenoptic camera 1.0.

The sensor element MS is positioned at a distance z₁ from the micro-lens array MLA, which in turn is located at a distance z₀ from the source S which is the same as the distance between the object OBJ and the source itself.

As already stated, the distance z₀ between the object OBJ and the source S, and between the plane π and the source S, may have any length in the case of a source S with chaotic light whereas, if the source S emits quantum correlated electromagnetic radiation, the distance z₀ must be such as to guarantee that the object OBJ and the plane π are in the far field of the source S itself.

In order that the micro-lenses form the image of the source, the following relationship must be met:

$$1 / {z}_{0} + 1 / {z}_{1} = 1 / {f}_{s} .$$

In order to form, on the micro-lenses, the indirect image of the object OBJ, the plane of the micro-lenses must be positioned at the distance z₀ from the source.

If the second relationship is not met, the images out of focus may be refocused by using the plenoptic information provided by the plenoptic image acquisition device PC.

As in the case of device 60, the value RFI represents the operating interval of the plenoptic camera PC, i.e., the beam of parallel planes for which it is possible to refocus the indirect image of the object OBJ.

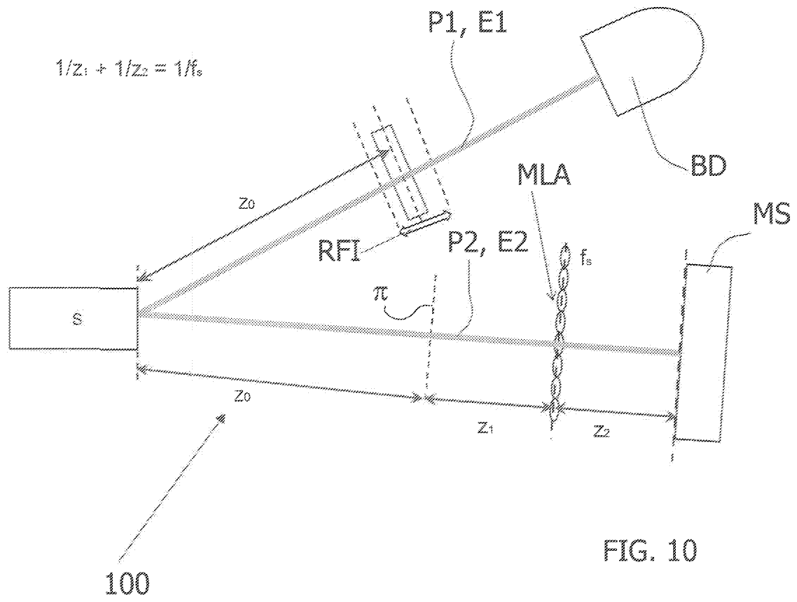

With reference to FIG. 10, the device 100 is configured as a modification of the device 80 without the main lens ML, and wherein the micro-lens array MLA is arranged at a distance z₁ from the focusing plane π of the indirect image. The plenoptic image acquisition device PC of the device 100 is of the type commonly known as plenoptic camera 2.0.

The sensor element MS is positioned at a distance z₂ from the micro-lens array MLA, which in turn is located at a distance z₁ from plane π, the latter being located at a distance z₀ from source S (which distance is the same as the distance between the object OBJ and the source itself). As already stated in the foregoing, the distance z₀ between the object OBJ and the source S, and between the plane π and the source S, may be of any length in the case of a source S with chaotic light whereas, if the source S emits quantum correlated electromagnetic radiation, the distance z₀ must ensure that the object OBJ and the plane π are in the far field of the source S itself.

The images out of focus on plane π may be refocused by using the plenoptic information provided by the plenoptic image acquisition device PC.

In order to make the indirect image focused on the plane π, the following relation must be true: 1/z₁+1/z₂=1/fₛ. If not, the images out of focus may be refocused by using the plenoptic information provided by the plenoptic image acquisition device PC.

As in the case of device 60, the value RFI represents the operating interval of the plenoptic camera PC, i.e., the beam of parallel planes for which it is possible to refocus the indirect image of the object OBJ.

The general operation of the devices 10-100 will now be described.

Each of the devices 10-100 is configured for the plenoptic reconstruction of indirect images (ghost image) of the object OBJ. Unlike the ghost imaging techniques of the known art, the devices according to the invention are not constrained by the positioning of the object in a specific plane, because they make it possible to refocus the indirect images out of focus by making use of the features of the plenoptic image acquisition device PC. In other words, in comparison with the known devices, the spatial arm uses a plenoptic image acquisition device instead of a conventional image acquisition device offering a bi-dimensional acquisition.

With the devices 10-100 it is possible to obtain the plenoptic reconstruction of indirect images of an object by means of a method comprising the following steps:

A method for the plenoptic reconstruction of indirect images comprising:
propagating a first electromagnetic emission E1 and a second electromagnetic emission E2 from the source S, the first electromagnetic emission E1 having a first propagation path P1, the second electromagnetic emission E2 having a second propagation path P2,
placing an object OBJ, of which an indirect image is to be reconstructed, along said first propagation path P1,
detecting intensity information of said first electromagnetic emission by means of a first electromagnetic emission detector BD comprising a first sensor element configured to emit a first signal proportional to an intensity of said first electromagnetic emission E1 impinging upon the first sensor, the object OBJ being arranged along the first propagation path P1 between the source(S) and the first electromagnetic emission detector,
detecting intensity information of said second electromagnetic emission by means of a second electromagnetic emission detector PC, the second electromagnetic emission detector comprising a plenoptic image acquisition device, the plenoptic image acquisition device comprising a second sensor element configured to detect a spatial distribution of the intensity of the second electromagnetic emission E2, and information about a direction of origin of the second electromagnetic emission E2 at a plurality of spatial locations on the second sensor element,
reconstructing an indirect image of said object OBJ by means of a correlation measure, over a time interval, of first signals from the first electromagnetic emission detector BD and second signals from the second electromagnetic emission detector PC, wherein:

each first signal is proportional to an intensity of said first electromagnetic emission E1,

each second signal comprises spatial distribution information of the intensity of the second electromagnetic emission E2, and information about a direction origin of the second electromagnetic emission E2 at a plurality of spatial locations on said second sensor element.

The reconstruction of the image of the object OBJ is obtained by means of an algorithm which combines the time sequence of the signal emitted by the detector BD due to the interaction with the electromagnetic emission E1 and the signal related to each pixel of the plenoptic image acquisition device PC, and which provides a measure of the statistical dependence thereof.

A class of algorithms ideally comprises two parts: the former consists in the reconstruction of the intensity distribution of the emission E2 on the plane correlated to the plane of the object OBJ by means of a combination of the pixel signals of the plenoptic image acquisition device PC. This part of the algorithm depends on the type of plenoptic image acquisition device PC being used (see FIGS. 6 to 10). The second part of the algorithm envisages applying a statistical function which provides a measure of the dependence between each point of the reconstructed image of the emission E2 and the signal of the detector BD.

The information about the image of the object OBJ and about the direction of the light which interacts therewith is contained in a function S(xⱼ), wherein xⱼ is the position of the j^{th} pixel of the reconstructed frame of the intensity distribution of the emission E2 (starting from the measure of the plenoptic image acquisition device PC).

Generally speaking, S(xⱼ) involves the correlation functions between the signal N₁ acquired by the bucket BD and the signal N₂(xⱼ) acquired by each pixel of the plenoptic camera PC. An example of statistical function is the covariance which provides an array of values, in the same number as the pixels of the plenoptic image acquisition device PC, obtained in the following way: for each pixel of the plenoptic image acquisition device PC an estimate is made of the time average of the product of the difference between the value thereof and the average thereof by the difference between the signal of detector BD and the average thereof:

$$S ( {x}_{j} ) = 〈 ( {N}_{1} - 〈 {N}_{1} 〉 ) ( {N}_{2} ( {x}_{j} ) - 〈 {N}_{2} ( {x}_{j} ) 〉 ) 〉$$

Another example is the Pearson correlation coefficient, i.e., pixel by pixel, the value of the covariance divided by the product of the standard deviation of the signal of the pixel and the signal of the detector BD.

A further example is the correlation coefficient for the ghost imaging, differential i.e., the covariance (pixel by pixel) of the plenoptic image acquisition device PC and of the detector BD, wherefrom there is subtracted the sum of all the pixels of the reconstructed image multiplied by the time average of the detector BD, divided by the time average of the sum of the pixels of the plenoptic image acquisition device PC.

An alternative algorithm, which however yields equivalent results, envisages calculating the statistical function mentioned in the foregoing between the detector BD and the signal of each pixel of the sensor MS of the plenoptic image acquisition device PC. Subsequently, the plenoptic reconstruction algorithm of each diagram will be applied to the resulting array.

Thanks to the devices 10-100 according to the invention it is possible to widen the applicability field of the indirect image reconstruction (ghost imaging) because, even if the object OBJ is not located in such a way as to meet the focusing conditions on the plane π, the images out of focus may be refocused by using the plenoptic information provided by the plenoptic image acquisition device PC. In other words, although the indirect image is visible only after the evaluation of the correlations, if such image is out of focus it is possible to refocus it by using the data available in the plenoptic acquisition. It is therefore possible to reconstruct the indirect image of objects no matter where such objects are located, as well as the indirect image of moving objects.

Of course, the implementation details and the embodiments may amply vary with respect to what has been described and illustrated in the foregoing, without departing from the extent of protection of the present invention, as defined by the annexed claims.

1. A device for the plenoptic reconstruction of indirect images of an object, comprising:
a first electromagnetic emission detector configured to be impinged by a first electromagnetic emission coming from a source and having a first propagation path, wherein during use the object of which the indirect image is to be reconstructed is arranged along the first propagation path in a position between the source and the first electromagnetic emission detector,
a second electromagnetic emission detector configured to be impinged by a second electromagnetic emission from said source and having a second propagation path,
wherein:
the first electromagnetic emission detector comprises a first sensor element configured to emit a signal proportional to an intensity of the first electromagnetic emission impinging upon the first sensor element, and
the second electromagnetic emission detector comprises a plenoptic image acquisition device, the plenoptic image acquisition device comprising a second sensor element configured to detect a spatial distribution information of an intensity of the second electromagnetic emission, and an information about a direction of origin of the second electromagnetic emission at a plurality of spatial locations on the second sensor element.

2. The device according to claim 1, further comprising a processing unit configured to reconstruct an indirect image of said object by means of a correlation measurement, over a time interval, of first signals from the first electromagnetic emission detector and second signals from the second electromagnetic emission detector, wherein:
each first signal is proportional to the intensity of said first electromagnetic emission,
each second signal comprises the spatial distribution information of the intensity of said second electromagnetic emission, and the information about the direction of origin of said second electromagnetic emission at the plurality of spatial positions on said second sensor element.

3. The device according to claim 1, wherein said first electromagnetic emission and second electromagnetic emission are separate secondary electromagnetic emissions from a same primary electromagnetic emission of the source.

4. The device according to claim 1, wherein said first electromagnetic emission and said second electromagnetic emission are primary electromagnetic emissions, correlated with each other, of the source.

5. A method for the plenoptic reconstruction of indirect images comprising:
propagating a first electromagnetic emission and a second electromagnetic emission from a source, the first electromagnetic emission having a first propagation path, the second electromagnetic emission having a second propagation path,
placing an object, of which an indirect image is to be reconstructed, along said first propagation path,
detecting an intensity information of said first electromagnetic emission by means of a first electromagnetic emission detector comprising a first sensor element configured to emit a first signal proportional to an intensity of said first electromagnetic emission impinging on said first sensor element, wherein said object is arranged along said first propagation path between said source and said first electromagnetic emission detector,
detecting an intensity information of said second electromagnetic emission by means of a second electromagnetic emission detector, the second electromagnetic emission detector comprising a plenoptic image acquisition device, the plenoptic image acquisition device comprising a second sensor element configured to detect a spatial distribution of an intensity of the second electromagnetic emission, and an information about a direction of origin of the second electromagnetic emission at a plurality of spatial locations on the second sensor element,
reconstructing an indirect image of said object by means of a correlation measurement, over a time interval, of first signals from the first electromagnetic emission detector and second signals from the second electromagnetic emission detector,
wherein:
each first signal is proportional to the intensity of said first electromagnetic emission,
each second signal comprises the spatial distribution information of the intensity of said second electromagnetic emission, and the information about the direction of origin of said second electromagnetic emission at the plurality of spatial locations on said second sensor element.

6. The method according to claim 5, wherein said first electromagnetic emission and second electromagnetic emission are separate secondary electromagnetic emissions from a same primary electromagnetic emission of said source.

7. The method of claim 6, wherein said first electromagnetic emission and said second electromagnetic emission are correlated primary electromagnetic emissions from said source.

8. The method of claim 5, wherein said reconstructing the indirect image of said object by means of the correlation measurement comprises reconstructing said second electromagnetic emission on a focusing plane using said second signals, wherein said focusing plane is arranged upstream of said second electromagnetic emission detector.
